(19) United States
(12) Patent Application Publication
(10) Pub. No.: US 2008/0099286 A1
(43) Pub. Date: May 1, 2008

(54) Brake system by see-saw movement for in-line roller skate

(76) Inventor: Max Dalho Lee, Wheeling, IL (US)

Correspondence Address: Max Dalho Lee, 230 Mayer Ave, Wheeling, IL, 60090, US

(21) Appl. No.: 11/589,653

(22) Filed: Oct. 30, 2006

(51) Int. Cl. B60T 1/00

(52) U.S. Cl. 188/29

(57) ABSTRACT

Function of braking is performed by pivotally mounted wheel frames which are divided and move see-saw movement. The see-saw movement of wheel frames or main frame induce resistance between wheels and brake pads which are locate at frontend and rearend of the main frame.

### FIELD OF SEARCH

References cited

| | | |
|---|---|---|
| 6 955 360 | October 2005 | Krivulin |
| 6 948 723 | September 2005 | bellehumeur etal |
| 6 874 794 | April 2005 | holland |
| 6 729 628 | May 2004 | bellehumeur etal |
| 6 666 462 | December 2003 | bellehumeur etal |
| 6 598 887 | July 2003 | haldemann |
| 6 478 312 | November 2002 | petrucci etal |
| 6 435 525 | August 2002 | penicaut |
| 6 279 921 | August 2001 | bozinovic zoran |
| 6 273 436 | August 2001 | repucci |
| 6 217 038 | April 2001 | moe |
| 6 131 920 | October 2000 | roman etal |
| 6 098 997 | August 2000 | cheng |
| 6 089 579 | July 2000 | pellegrini jr. etal |
| 5 791 665 | August 1998 | mayer ll |
| 5 758 884 | June 1998 | flater |
| 5 755 450 | May 1998 | ellis etal |
| 5 752 707 | May 1998 | cottle etal |
| 5 551 712 | September 1996 | repucci |
| 5 501 474 | March 1996 | conte |
| 5 486 011 | January 1996 | nelson |
| 5 183 275 | February 1993 | hoskin |
| 5 088 748 | February 1992 | koselka etal |

Description

### BACKGROUND OF INVENTION

This invention provide speed reduction of all directions for roller in-line skate.

1. Prior Art

It is difficult to reduce speed in-line roller skate. Specialy when they ride sideward or backward,speed reduction is more difficult. They just wait to stop, or push cars or peoples to stop.

2. This invention

This invention provide slow or fast stop in any directions forward, backward or sideward.

### DESCRIPTION OF DRAWINGS

FIG. 1 Overall sideview

FIG. 2 Explored view

FIG. 3 Detailed invention side view

FIG. 4 Bottomside view of main frame

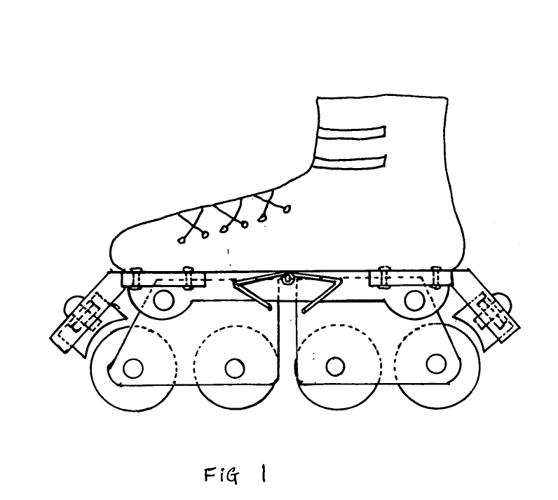

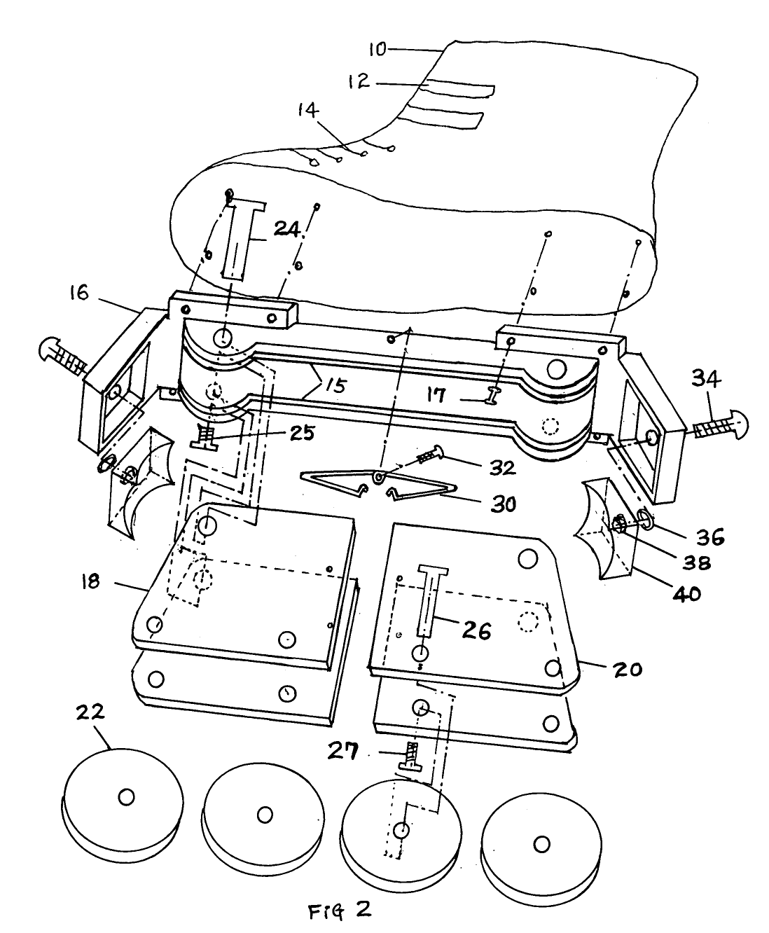

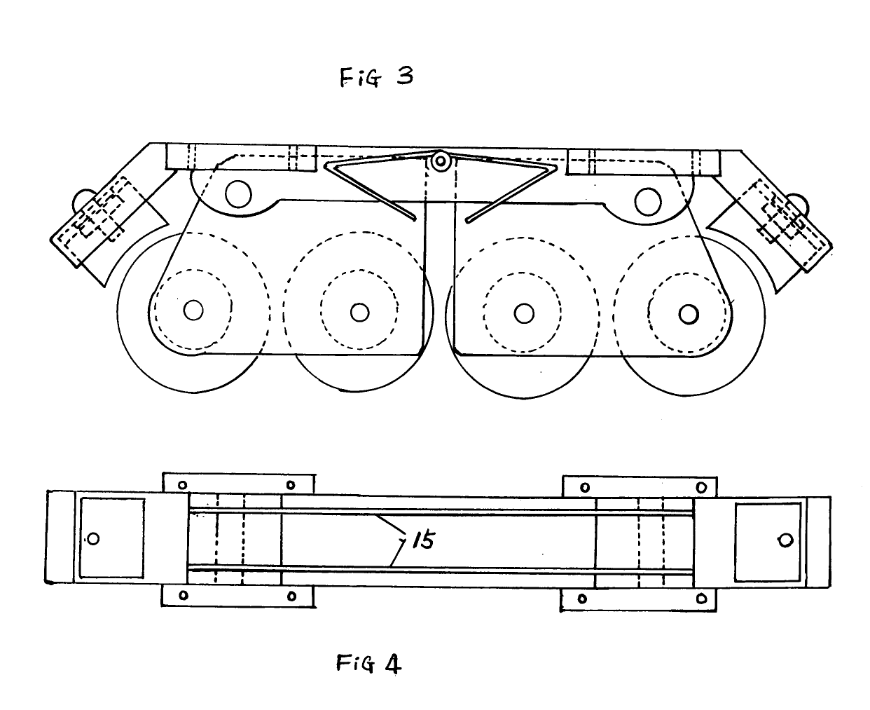

### DRAWING—REFERENCE NUMERALS

10 skate boot

12 stripers of boot

14 string ties

16 main frame

17 rivets

18 front wheel hold frame

20 rear wheel hold frame

22 bearing loaded wheel

24 truncated nut for wheel frame

25 Bolt

26 truncated nut for wheel

27 Bolt

30 frame hold spring

32 screw for spring

34 screw for brake pad

36 screw retainer for brake pad

38 nut in brake pad

40 brake dad

### DETAILED DESCRIPTION OF THE INVENTION

Main frame is made with hard plastic. Frontend and rearend of the main frame have rubbermaid brake pad 40. Said brake pad contain nut 38.

screw 34 is fixed in main frame by screw retain washer 36. Main frame have horizontal grooves 15 from end of front brake to begin of rear brake for holding and supporting two pair of wheel frame 18,20. Main frame is attached to boot by rivets 17. The main frame and two pairs of wheel frames are connect by truncated nuts 24 and screws 25. Wheel frames are two pairs of vertical aluminum panels for frontside and rearside. Each wheel frame have two bearing loaded wheels 22 which installed with truncated nuts 26 and screws 27. Spring 30 which attached at both side of center of the mainframe are connect to upper center corner of wheel frames.

### Operation of the Invention

In order to reduce speed,move your right or left foot aproximatly one foot to forward and sideward for body balance then lift up toe of front foot and lift up heel of rear foot simultaniously. Thus front and rear brake pads are press to the corrasponing wheel by see-saw movement of mainframe or wheel frame. If you lift toe and heel hard, press force is bigger when you ride forward backward or sideward, lift up toe and heel or toe and toe or heel and heel, brake action is performed.

1. Brake system is performed by pivotally mounted wheel frames which are divided and perform see-saw movement, and the see-saw movement of wheel frames or main frame induce resistance between wheels and brake pads which are installed at frontend and rearend of the main frame, and horizontal deep groove to support the vertical divided wheel frames.
